(19) United States
(12) Patent Application Publication
(10) Pub. No.: US 2011/0299122 A1
(43) Pub. Date: Dec. 8, 2011

(54) IMAGE FORMING APPARATUS AND SYSTEM

(76) Inventor: Takahiro KAWAKAMI, Osaka (JP)

(21) Appl. No.: 13/152,372

(22) Filed: Jun. 3, 2011

(30) Foreign Application Priority Data
Jun. 4, 2010 (JP) 2010-128835

(51) Int. Cl. G06F 3/12

(52) U.S. Cl. 358/1.15

(57) ABSTRACT

In a system provided with an information processing apparatus for requesting a job, an image forming apparatus for processing the job, and a server for managing the job, it is enabled to request a job from the information processing apparatus for execution even when the server is down at least to a status where the job can not be received. The image forming apparatus is provided with a detecting portion for detecting that the server is down, a direct receiving portion for, when it is detected that the server is down, directly receiving a target job to be processed by the image forming apparatus from the information processing apparatus, and a distributing portion for, when it is detected that the server is down, distributing a message or an e-mail including information indicating that the server is down to the information processing apparatus or a user of the information processing apparatus.

### CROSS-NOTING PARAGRAPH

This non-provisional application claims priority under 35 U.S.C. §119(a) on Patent Application No. 2010-128835 filed in JAPAN on Jun. 4, 2010, the entire contents of which are hereby incorporated herein by reference.

### FIELD OF THE INVENTION

The present invention relates to an image forming apparatus, and a system provided with the image forming apparatus, an information processing apparatus, and a server for managing jobs executed by the image forming apparatus.

### BACKGROUND OF THE INVENTION

Conventionally, in a system which a plurality of image forming apparatuses are controlled centrally by a server, when the server is down because of failure or the like, it becomes impossible to execute a job transmitted from an information processing apparatus such as a personal computer (PC) serving as a client apparatus.

On the other hand, a system described in Japanese Laid-Open Patent Publication No. 2005-318108 enables to continue printing by an alternative means when a storage device of a server fails. In addition, in a system described in Japanese Laid-Open Patent Publication No. 2005-128966, a server notifies a user of failure of an image forming apparatus by an e-mail.

However, in the system described in Japanese Laid-Open Patent Publication No. 2005-318108, when not only the storage device of the server fails but the server is down completely, printing data can not be transferred to anywhere, and the printing comes to a stop. Note that, Japanese Laid-Open Patent Publication No. 2005-128966 only describes processing for failure of an image forming apparatus, but does not describe a recovering method for the case where the server fails.

Accordingly, in the technology described in Japanese Laid-Open Patent Publication No. 2005-318108 and Japanese Laid-Open Patent Publication No. 2005-128966, at least when it becomes impossible to receive printing data in the server, such as when the server is down completely or a communication interface fails, the printing job can not be requested, or even if the printing job can be requested, a communication error is caused, and printing can not be executed as a result. In particular, it is very inconvenient when it is desired to request an urgent printing job.

### SUMMARY OF THE INVENTION

An object of the present invention is to enable, in a system provided with an information processing apparatus for requesting a job, an image forming apparatus for processing the job, and a server for managing the job processed by the image forming apparatus, to request the job from the information processing apparatus and to execute it, even when the server is down at least to a status where it is impossible to receive the job.

A first technical means of the present invention is an image forming apparatus configured to be connected with an information processing apparatus and a server through a network, wherein the server manages a job that is requested from the information processing apparatus and processed by the image forming apparatus, and the image forming apparatus comprises: a detecting portion for detecting that the server is down; a direct receiving portion for directly receiving a target job to be processed by the image forming apparatus from the information processing apparatus when the detecting portion detects that the server is down; and a distributing portion for distributing a message or an e-mail including information indicating that the server is down to the information processing apparatus or a user of the information processing apparatus when the detecting portion detects that the server is down.

A second technical means is the image forming apparatus as defined in the first technical means, further comprising a holding portion for holding user information indicating a user of the information processing apparatus that transmitted the job and processing content of the job at least until the server recovers.

A third technical means is the image forming apparatus as defined in the second technical means, further comprising a notifying portion for notifying the server of the user information and the processing content held by the holding portion when the detecting portion detects that the server has recovered.

A fourth technical means is the image forming apparatus as defined in the first technical means, comprising an authenticating portion for authenticating the user of the information processing apparatus as a user of the image forming apparatus in conjunction with the server, wherein the message or the e-mail includes information indicating that user authentication is exempted.

A fifth technical means is the image forming apparatus as defined in the first technical means, wherein the message or the e-mail includes information indicating that the job is directly transmitted to the image forming apparatus.

A sixth technical means is the image forming apparatus as defined in the first technical means, further comprising a setting portion for setting for each user of the information processing apparatus whether or not to permit an operation in the direct receiving portion and the distributing portion.

A seventh technical means is the image forming apparatus as defined in the sixth technical means, wherein setting at the setting portion is accepted only from an administrating user who corresponds to an administrator of the server.

An eighth technical means is a system in which the image forming apparatus as defined in the first technical means, and, an information processing apparatus and a server are connected to the image forming apparatus through a network, wherein the server manages a job that is requested from the information processing apparatus and processed by the image forming apparatus.

### BRIEF DESCRIPTION OF THE DRAWINGS

FIG. 1 is a schematic view showing an exemplary configuration of a system according to the present invention;

FIG. 2 is a view showing an example of job information managed by a printing management server of FIG. 1;

FIG. 3 is a view showing an example of a screen that is displayed when a printing job is transmitted to a printing apparatus to give a printing instruction in a PC of the system of FIG. 1;

FIG. 4 is a flowchart for explaining exemplary processing in the printing apparatus of the system of FIG. 1;

FIG. 5 is a flowchart for explaining an example of a method for detecting that the server is down in FIG. 4; and

FIG. 6 is a flowchart for explaining another example of the method for detecting that the server is down in FIG. 4.

### PREFERRED EMBODIMENTS OF THE INVENTION

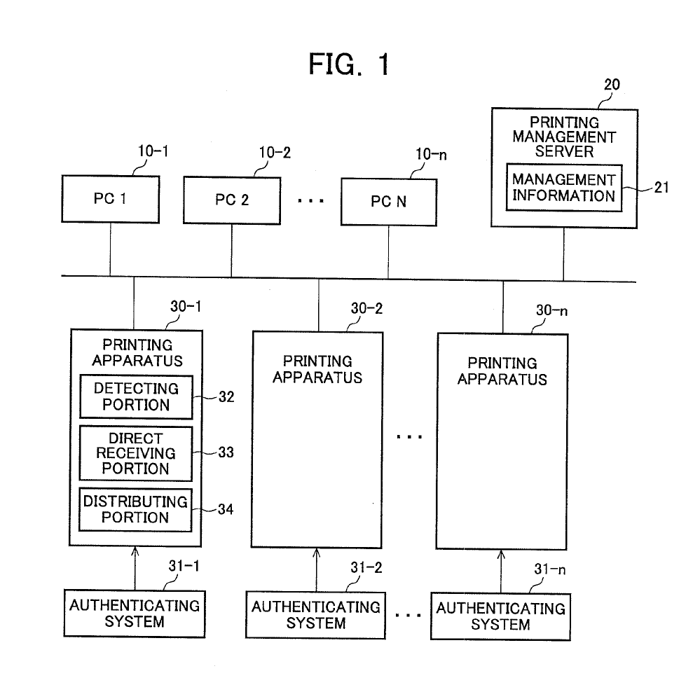

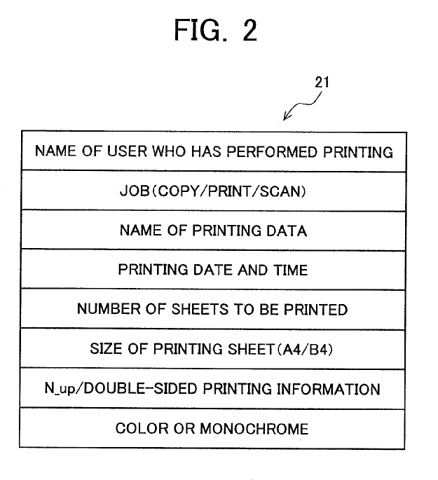

FIG. 1 is a schematic view showing an exemplary configuration of a system according to the present invention, and FIG. 2 is a view showing an example of job information managed by a printing management server of FIG. 1.

The system illustrated in FIG. 1 as an example is provided with information processing apparatuses illustrated as PCs 10-1 to 10-n, a server illustrated as a printing management server 20, and image forming apparatuses illustrated as printing apparatuses 30-1 to 30-n. The image forming apparatus is preferably a multi-functional peripheral having multiple functions since it can cope with other kinds of jobs, but may be a simple printer. To the image forming apparatuses according to the present invention, one or more information processing apparatuses are connected through a network in this manner and the server is connected through the network. Moreover, in this system, only one image forming apparatus may be connected. The system will be often described by taking any of the PCs 10-1 to 10-n as a PC 10 and any of the printing apparatuses 30-1 to 30-n as a printing apparatus 30.

The printing management server 20 manages a job requested from the PC 10 and processed by the printing apparatus 30. That is, the printing management server 20 centrally manages jobs processed by a plurality of the printing apparatuses 30. However, the system according to the present invention may be provided with a server capable of managing one or more kinds of jobs among various jobs such as not only a printing job but also a job for storing a scanned file in an image forming apparatus, a job for transmitting an e-mail attached with an existing file or a scanned file, and a job for transmitting an existing file or a scanned file by FTP (File Transfer Protocol). Although a server will be described below by taking the above-described printing management server 20 as an example of the server, the following description can be also basically incorporated in the same manner for jobs other than a printing job.

Moreover, authenticating systems 31-1 to 31-n are connected to the printing apparatuses 30-1 to 30-n, respectively. An authenticating system will be often described below by taking any of the authenticating systems 31-1 to 31-n as an authenticating system 31. The authenticating system 31 is an authenticating portion for authenticating whether or not a user can use the printing apparatus 30 by key input of a user ID and a password, by reading an IC (Integrated Circuit) card, or the like, and may be incorporated in each of the printing apparatuses 30 or connected externally. The information for authenticating the user is input from the PC 10, but can be also input in the authenticating portion of the printing apparatus 30. In addition, the authenticating portion authenticates a user of the PC 10 as a user of the printing apparatus 30 in conjunction with the printing management server 20. Moreover, as an alternative configuration for external connection, it may be possible that the authenticating systems 31-1 to 31-n are constructed collectively as a common authenticating server and connected to the above-described network. The common authenticating server receives information for authentication that is input by the PC 10 and the printing apparatus 30, executes user authenticating processing in conjunction with the printing management server 20, and permits printing only when the authentication is OK.

When printing is performed from the PC 10 in such a system, for example, the following processing is performed. First, a printing instruction is given after a user inputs a user ID and password in the PC 10, and a printer driver of the PC 10 transmits a printing job including printing data and user information (the user ID and the password in this case) to the printing management server 20. The printing management server 20 firstly transmits the above-described user information for authentication to the printing apparatus 30 to which the printing instruction is given or the authenticating system 31 of the printing apparatus 30 that is sorted as an execution destination by the printing management server 20 in order to authenticate if the printing job may be executed. The printing management server 20 receives the authentication result, and when the authentication is OK, transmits the printing job to the printing apparatus 30, and printing is executed in the printing apparatus 30. On the other hand, when the authentication is NG, that is communicated to the PC 10, and printing is not executed. Note that, such processing procedure may be employed that the PC 10 transmits printing data when the authentication is OK after the user information is transmitted.

Moreover, when copying, information for authentication is input in the authenticating system 31 of the printing apparatus 30, user authentication processing is performed in the authenticating system 31, and the authentication result is transmitted to the printing management server 20. When the authentication result shows that the authentication is OK, the printing management server 20 permits use of the printing apparatus 30 and log-in to the printing apparatus 30 is completed. Then, the user sets a document in the printing apparatus 30 and presses an execute key to execute copying. On the other hand, when the authentication is NG, use of the printing apparatus 30 is not permitted, and a log-in error is presented to the user in the printing apparatus 30.

Then, the printing management server 20 manages that printing is executed in this manner as management information 21. The management information 21 includes, for example, as shown in FIG. 2, information showing a name of a user who has performed printing, a job type (copying, printing or scanning, etc.), a name of printing data, printing date and time, the number of sheets to be printed, a size of a printing sheet (A4 or B4, etc.), N-up (intensive printing) or double-sided printing, information showing color/monochrome, and the like. Here, security management is performed by means of a file name, a user name, and date and time. In addition, statistical management is performed by means of printing information such as the number of sheets to be printed, a sheet size, and color/monochrome. The statistical management is also called ecological management because the degree of saving can be also managed.

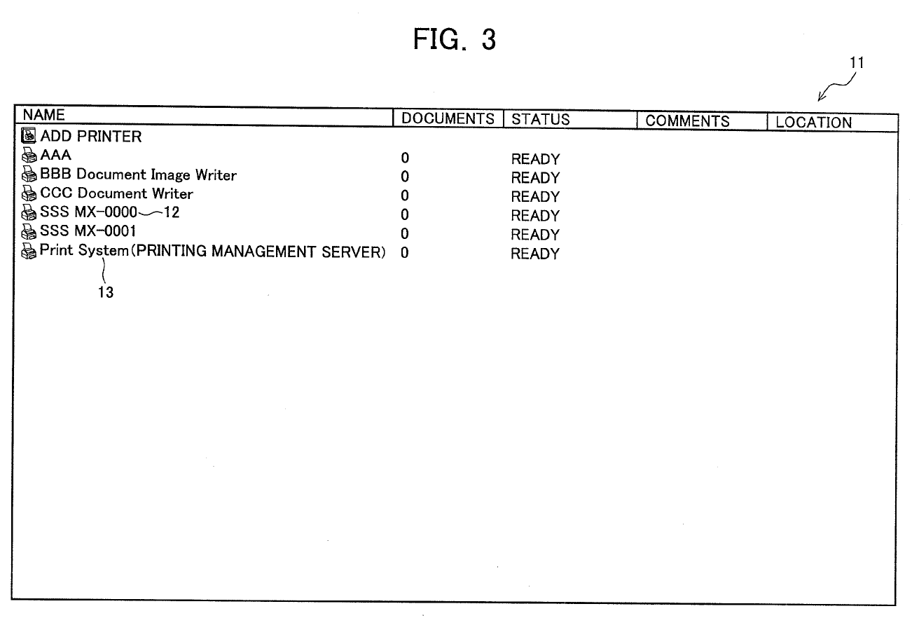

Next, the main features of the present invention will be described with reference to FIGS. 3 to 6. FIG. 3 is a view showing an example of a screen that is displayed when a printing job is transmitted to a printing apparatus to give a printing instruction in a PC of the system of FIG. 1.

The printing apparatus 30 is an apparatus that is arranged as a component of such a system and is provided with a detecting portion 32, a direct receiving portion 33, and a distributing portion 34 as the main features of the present invention. Each of the portions 32 to 34 is mainly configured by a network interface, a computing device in a controlling portion of the printing apparatus 30, a working memory, a memory recording a control program, and the control program. In addition, the function of each of the portions 32 to 34 can be realized when the printing apparatus 30 is controlled by the control program. Note that, although the portions 32 to 34 are depicted only in the printing apparatus 30-1 in FIG. 1, the portions 32 to 34 are also included in other printing apparatuses 30-2 to 30-n in the same manner.

The detecting portion 32 detects that the printing management server 20 is down. As to a method for detection, an example of which will be described below, detection is carried out by monitoring presence of the printing management server 20 on the network basically. Of course, such an apparatus that does not carry out monitoring of the network but carries out direct monitoring may be provided. That the printing management server 20 is down refers to at least a status where processing for receiving a printing job can not be performed such as that the power fails, that a communication interface fails or that a data receiving function overflows.

When the detecting portion 32 detects that the printing management server 20 is down, the direct receiving portion 33 directly receives a target job to be processed by the printing apparatus 30 from the PC 10. That is, the direct receiving portion 33 makes it possible to receive a printing job directly from the PC 10. For example, the direct receiving portion 33 makes ready to receive a printing job, if its own IP address is included in the printing job by referring to an IP address of a printing job distributed on the network. Note that, until it is detected that the server is down, it may be set such that a printing job is received only from the printing management server 20.

Moreover, although it is assumed that the PC 10 transmits a printing job to the printing management server 20 and the printing management server 20 transfers the printing job to the printing apparatus 30, it may be configured such that only printing setting that is kept as the management information 21 is transmitted to the printing management server 20 and, preferably, after obtaining permission from the printing management server 20, printing data itself is transmitted to the printing apparatus 30 for executing printing. When such processing procedure is employed, the PC 10 directly transmits a printing job to the printing apparatus 30 even when the printing management server 20 is not down. That is, when such processing is employed, it is only required to directly receive a job by the direct receiving portion 33, whether or not the printing management server 20 is down.

When the detecting portion 32 detects that the printing management server 20 is down, the distributing portion 34 distributes a message or an e-mail including information indicates that the printing management server 20 is down to the PC 10 or a user thereof.

Distribution by the distributing portion 34 will be described in detail. In general, when distributing to the PC 10, the distribution is performed by a message, and when distributing electronically to a user, the distribution is performed by an e-mail, whereas, distribution may be also performed in this manner in the distributing portion 34. Of course, when one PC 10 is allocated for a user, distribution to the PC 10 means distribution to the user, which may be performed whether by a message or an e-mail. In the configuration where the distributing portion 34 transmits messages, for example, the messages may be distributed all together to IP addresses of the PCs 10 that are stored in advance, and in the configuration where the distributing portion 34 transmits e-mails, for example, the e-mails may be distributed all together to e-mail addresses that are stored in advance. That is, distribution of e-mails or messages may be performed by broadband distribution for all the PCs 10 that have been registered inside the printing apparatus 30 and users thereof. Here, inside of the printing apparatus 30 may be of course inside of the authenticating system 31, and it may be possible to include in or correlate to information used for matching at the time of authenticating a user. Such processing allows the user to perform an operation of selecting the printing apparatus 30 manually at least when the server is down. However, the distributing portion 34 may distribute an e-mail or a message only to the PC 10 that has requested a job while the printing management server 20 is down and a user thereof.

Such distribution allows the user to know that the printing management server 20 is down, so that it is possible to directly select the printing apparatus 30 and give a printing instruction. For example, upon an instruction by the user who sees such an e-mail or a message, the PC 10 displays a printer selection screen 11 as depicted in FIG. 3, so that it is possible to select an icon of a desired printer (for example, an icon 12 of a printer whose name is “SSS MX-000”) to give a printing instruction. Alternatively, when receiving such a message or an e-mail, the PC 10 may change setting automatically so as to directly transmit to the printing apparatus 30 shown by the above-described icon 12. Here, in the printer selection screen 11, an icon 13 of a printer shown with a name of “Print System” indicates an icon of a driver that transmits a printing job to the printing management server 20, and in general this icon 13 is selected so that a printing job is always transmitted to the printing management server 20.

In this manner, according to the present invention, even when the printing management server 20 is down at least to the status where a job can not be received, it is possible to request a printing job from the PC 10 for execution. Note that, as long as a printing job is received, it is possible to execute the printing job by the printing apparatus 30 upon the instruction from the printing management server 20, even though it is after the printing management server 20 recovers. In addition it is not necessary to provide a backup server serving as a backup for the printing management server 20.

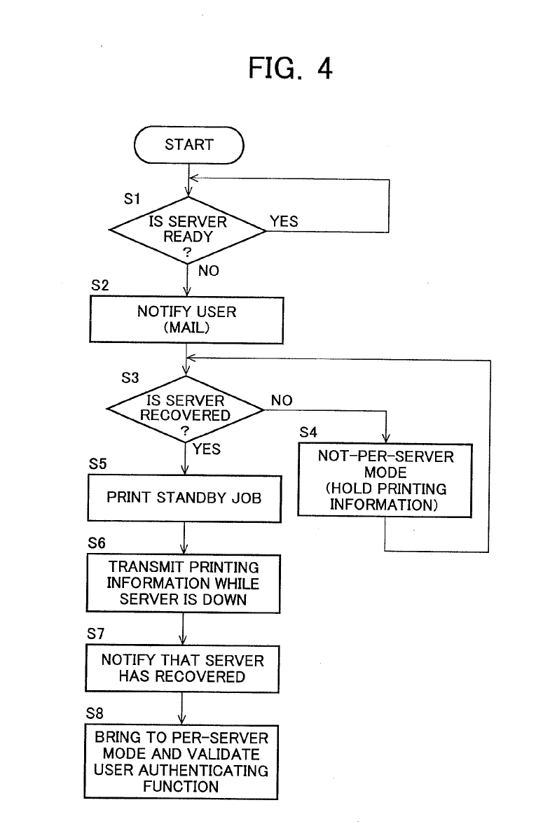

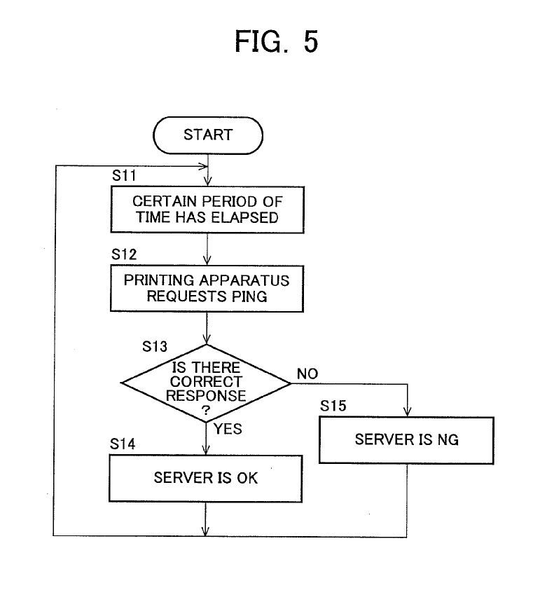

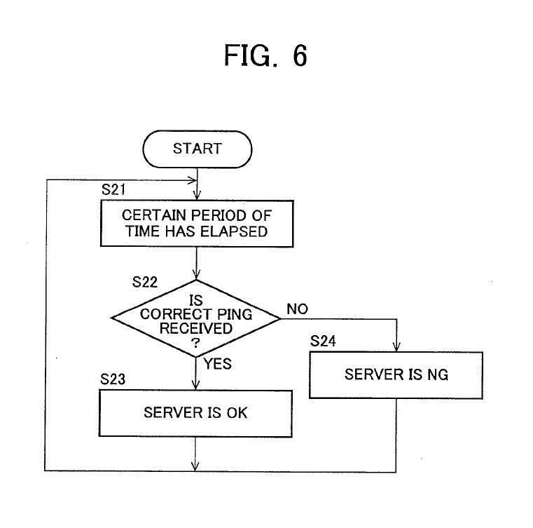

Next, an example of the flow of printing processing in such a system will be described with reference to FIGS. 4 to 6. Moreover, FIG. 4 is a flowchart for explaining exemplary processing in the printing apparatus of the system of FIG. 1, FIG. 5 is a flowchart for explaining an example of a method for detecting that the server is down in FIG. 4, and FIG. 6 is a flowchart for explaining another example of the method for detecting that the server is down in FIG. 4.

First, the printing apparatus 30 detects whether or not the printing management server 20 is ready (step S1). As step S1, the detecting method depicted in FIG. 5, the detecting method depicted in FIG. 6, or the like may be employed.

In the detecting method depicted in FIG. 5, the printing apparatus 30 periodically, that is, after waiting for a certain period of time (step S11), requests PING to the printing management server 20 (step S12), and determines whether or not a response thereto is returned correctly (step S13). When the response is not returned (in the case of NO at step S13), the printing apparatus 30 detects that the server is down (step S15), and the flow goes back to step S11. On the other hand, when the response is returned (in the case of YES at step S13), the printing apparatus 30 detects that the server is not down (step S14), and the flow goes back to step S11.

The detecting method depicted in FIG. 6 is performed such that the printing management server 20 periodically requests PING to the printing apparatus 30, and the printing apparatus monitors the PING. More specifically, the printing apparatus 30 periodically, that is, after waiting for a certain period of time (step S21), determines whether or not correct PING is received (step S22), and when the PING is not received (in the case of NO at step S22), it is detected that the server is down (step S24), and the flow goes back to step S21. On the other hand, when the PING is received (in the case of YES at step S22), the printing apparatus 30 detects that the server is not down (step S23), and the flow goes back to step S11. In this manner, the printing apparatus 30 monitors the PING from the printing management server 20, and when the PING is not received for a certain period of time or more, determines that the server is down.

In the case of NO at step S1, that is, when the printing management server 20 is down, the printing apparatus 30 sends the notice that the server is down to an e-mail address or an IP address registered in the printing apparatus 30 by an e-mail or a message (step S2). Note that, the e-mail address may be an e-mail address registered for the scan and transmission function, which has no problem because the scan and transmission function is performed by a user operation for an e-mail address that can be generally viewed by the user. Moreover, for such notification, it is only required that the distributing portion 34 (and the detecting portion 32) are equipped at least in one printing apparatus 30 in the system of FIG. 1, and when the distributing portion 34 (and the detecting portion 32) are equipped in a plurality of the printing apparatuses 30, monitoring may be performed by the plurality of printing apparatuses 30 with information of a transmission source added to an e-mail or a message or with the detection timing shifted. Such monitoring makes it possible to cope with even when one of the printing apparatuses 30 is down.

In addition, an e-mail or a message may include information indicating (1) that the printing management sever 20 is down, (2) that user authentication is exempted until the printing management server 20 recovers, and (3) that printing data can be printed only after the printing data is directly transmitted to the printing apparatus 30, not to the printing management server 20.

As depicted in the above-described (2), a message or an e-mail preferably includes information indicating that user authentication is exempted. However, it is limited only to a configuration where the printing apparatus 30 is provided with the above-described authenticating portion. When being not down, the authenticating system 31 transmits the authentication result to the printing management server 20, by which printing job processing is permitted, whereas, when being down, it is impossible to determine whether or not to permit by the printing management server 20 eventually and the authentication result that is required for the determination needs not to be transmitted, thus making it possible to reduce processing with unnecessary authentication omitted.

As depicted in the above-described (3), a message or an e-mail preferably includes information indicating that a printing job is directly transmitted to the printing apparatus 30. A user who has read the message or the e-mail can recognize that the job is directly transmitted. In particular, it is preferable that a model name or a name of the printing apparatus 30 is included in the information.

The printing apparatus 30 then determines whether or not the printing management server 20 has recovered (step S3), and in the case of NO, brings or maintains to a not-per-server mode to function the direct receiving portion 33 (step S4). After the processing at step S4, the flow goes back to step S3. In this manner, while the printing management server 20 is down, data is transmitted not through the printing management server 20 but directly to the printing apparatus 30 for performing printing.

In addition, at step S4, when the printing job is received, printing information thereof is preferably held. Therefore, the printing apparatus 30 is preferably provided with a holding portion for holding user information showing a user of the PC 10 transmitting the printing job and processing content of the printing job at least until the printing management server 20 recovers. The holding portion has a memory. In addition, the above-described printing information includes the user information and the processing content described above. The user information to be held can be obtained from information included in or attached to the job, and in the configuration where the above-described authenticating portion is provided, may be held after confirming to be included in information for authentication. Note that, the holding portion is brought into a status capable of holding after notification of an e-mail or a message, but may be brought into a status capable of holding after the server is down and before notification. Since it is possible to continuously perform printing management on the side of the printing apparatus 30 after the server is down, data can be managed while the server is down.

In the case of YES at step S3, that is, when the printing management server 20 recovers, the printing apparatus 30 processes all the jobs during the non-per-server mode (step S5), the printing apparatus 30 transmits printing information that is saved to the printing management server 20 (step S6), and the printing management server 20 merges the printing information with management information. Step S5 may be executed in the case of NO at step S3.

In this manner, the printing apparatus 30 is preferably provided with the following notifying portion. That is, when the detecting portion 32 detects that the printing management server 20 has recovered, the notifying portion notifies the printing management server 20 of the user information and the processing content (such as the number of sheets to be printed) held by the holding portion. Since it is possible to obtain information about printing management while the printing management server 20 is down, printing management can be performed without interruption taking into account even while the printing management server 20 is down.

The printing apparatus 30 or the printing management server 20 sends the notice that the printing management server 20 has recovered to the PC 10 or a user thereof with an IP address or by an e-mail (step S7), and the printing apparatus 30 brings back to a per-server mode and also validates the user authenticating function (step S8).

Although it is assumed in the examples above that the printing apparatus 30 always performs the operation in the distributing portion 34 and the direct receiving portion 33, the printing apparatus 30 may be provided with the following setting portion. The setting portion sets, for each user of the PC 10, whether or not to permit the operation in the direct receiving portion 33 and the distributing portion 34. For the setting, the printing apparatus 30 may be provided with a user interface and a memory for storing setting content so that the setting is read out such as when a user who uses is defined. Actually, it is more desirable that user authentication is exempted only in a part of the image forming apparatuses for the security in operating the system, so that it is useful to provide such a setting portion. Moreover, it is preferable that setting at the setting portion be accepted only from an administrator user who corresponds to an administrator of the printing management server 20 for management.

As describe above, according to the present invention, in a system provided with an information processing apparatus for requesting a job, an image forming apparatus for processing the job, and a server for managing the job processed by the image forming apparatus, it is possible to request the job from the information processing apparatus for execution, even when the server is down at least to a status where the job can not be received.

1. An image forming apparatus configured to be connected with an information processing apparatus and a server through a network, wherein
the server manages a job that is requested from the information processing apparatus and processed by the image forming apparatus, and the image forming apparatus comprises:
a detecting portion for detecting that the server is down;
a direct receiving portion for directly receiving a target job to be processed by the image forming apparatus from the information processing apparatus when the detecting portion detects that the server is down; and
a distributing portion for distributing a message or an e-mail including information indicating that the server is down to the information processing apparatus or a user of the information processing apparatus when the detecting portion detects that the server is down.

2. The image forming apparatus as defined in claim 1, further comprising a holding portion for holding user information indicating a user of the information processing apparatus that transmitted the job and processing content of the job at least until the server recovers.

3. The image forming apparatus as defined in claim 2, further comprising a notifying portion for notifying the server of the user information and the processing content held by the holding portion when the detecting portion detects that the server has recovered.

4. The image forming apparatus as defined in claim 1, comprising an authenticating portion for authenticating the user of the information processing apparatus as a user of the image forming apparatus in conjunction with the server, wherein
the message or the e-mail includes information indicating that user authentication is exempted.

5. The image forming apparatus as defined in claim 1, wherein
the message or the e-mail includes information indicating that the job is directly transmitted to the image forming apparatus.

6. The image forming apparatus as defined in claim 1, further comprising a setting portion for setting for each user of the information processing apparatus whether or not to permit an operation in the direct receiving portion and the distributing portion.

7. The image forming apparatus as defined in claim 6, wherein
setting at the setting portion is accepted only from an administrating user who corresponds to an administrator of the server.

8. A system in which the image forming apparatus as defined in claim 1, and, an information processing apparatus and a server are connected to the image forming apparatus through a network, wherein
the server manages a job that is requested from the information processing apparatus and processed by the image forming apparatus.
